(19) United States
(12) Patent Application Publication
(10) Pub. No.: US 2026/0140696 A1
(43) Pub. Date: May 21, 2026

(54) Latency FIFO circuit and operation method thereof having low power dissipation mechanism

(71) Applicant: REALTEK SEMICONDUCTOR CORPORATION, HSINCHU (TW)

(72) Inventors: JEONG-FA SHEU, HSINCHU (TW); JHENG-YAN LIOU, HSINCHU (TW); YUN-SHENG LIN, HSINCHU (TW)

(21) Appl. No.: 19/367,156

(22) Filed: Oct. 23, 2025

(30) Foreign Application Priority Data
Nov. 18, 2024 (TW) 113144335

(51) Int. Cl. G06F 5/06

(52) U.S. Cl. CPC G06F 5/065

(57) ABSTRACT

A latency first-in-first-out (FIFO) circuit having a low power dissipation mechanism is provided that includes a counting circuit, FIFO buffers, an input circuit and an output circuit. The counting circuit in turn generates a counting value corresponding to one of reference values in a circular manner. Each of the FIFO buffers corresponds to a corresponding one of the reference values and includes stored data. The input circuit receives and writes the input data to one of the FIFO buffers according to the counting value. The output circuit selects the stored data of one of the FIFO buffers according to the counting value to be outputted as delayed data.

### BACKGROUND OF THE INVENTION

### 1. Field of the Invention

The present invention relates to a latency FIFO circuit and operation method thereof having a low power dissipation mechanism.

### 2. Description of Related Art

In a chip of a network switch that is required to have a high bandwidth, data on different data buses in each of clock cycles may correspond to information of different network packets. The data corresponding to the same packet transmitted in different data paths need to be aligned to a specific phase to form complete packet information to be processed. Under such a condition, a data storage circuit is required to store and delay the data that arrived first to be processed together with the data arrived later. However, the data storage circuit having a pipeline design consumes a lot of power consumption in each clock cycle due to the extensive data transfers.

### SUMMARY OF THE INVENTION

In consideration of the problem of the prior art, an object of the present invention is to supply a latency FIFO circuit and operation method thereof having a low power dissipation mechanism.

The present invention discloses a latency first-in-first-out (FIFO) circuit having a low power dissipation mechanism that includes a counting circuit, a plurality of FIFO buffers, an input circuit and an output circuit. The counting circuit in turn generates a counting value corresponding to one of a plurality of reference values in a circular manner. Each of the FIFO buffers corresponds to a corresponding one of the reference values and has stored data. The input circuit receives input data and writes the input data to one of the FIFO buffers according to the counting value. The output circuit selects one of the FIFO buffers to be a selected FIFO buffer according to the counting value and outputs the stored data in the selected FIFO buffer to be delayed data.

The present invention also discloses a latency FIFO circuit operation method having a low power dissipation mechanism that includes steps outlined below. A counting value corresponding to one of a plurality of reference values is generated in turn in a circular manner by a counting circuit. Each of a plurality of FIFO buffers is configured to correspond to a corresponding one of the plurality of reference values and have stored data. Input data is received and written to one of the FIFO buffers according to the counting value by an input circuit. One of the FIFO buffers is selected to be a selected FIFO buffer according to the counting value and the stored data in the selected FIFO buffer is outputted to be delayed data by an output circuit.

These and other objectives of the present invention will no doubt become obvious to those of ordinary skill in the art behind reading the following detailed description of the preferred embodiments that are illustrated in the various figures and drawings.

### BRIEF DESCRIPTION OF THE DRAWINGS

FIG. 1 illustrates a block diagram of a latency FIFO circuit having a low power dissipation mechanism according to an embodiment of the present invention.

FIG. 2 illustrates a block diagram of the counting circuit according to an embodiment of the present invention.

FIG. 3 illustrates block diagram of the input circuit according to an embodiment of the present invention.

FIG. 4 illustrates a block diagram of the output circuit according to an embodiment of the present invention.

FIG. 5 illustrates a block diagram of the counting circuit according to another embodiment of the present invention.

FIG. 6 illustrates a block diagram of a latency FIFO circuit having a low power dissipation mechanism according to an embodiment of the present invention.

FIG. 7 illustrates a flow chart of a latency FIFO circuit operation method having a low power dissipation mechanism according to an embodiment of the present invention.

### DETAILED DESCRIPTION OF THE PREFERRED EMBODIMENTS

An aspect of the present invention is to provide a latency FIFO circuit and operation method thereof having a low power dissipation mechanism to read and write FIFO buffers in turn in a circular manner according to the timing count of a counting circuit such that input data is outputted after a fixed delay time to avoid the power dissipation of data transfer among different FIFO buffers.

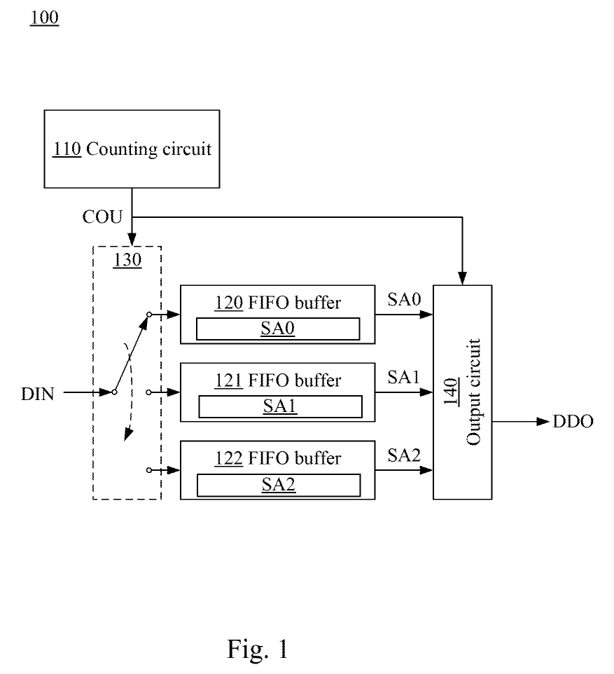

Reference is now made to FIG. 1. FIG. 1 illustrates a block diagram of a latency FIFO circuit 100 having a low power dissipation mechanism according to an embodiment of the present invention. The latency FIFO circuit 100 is configured to receive input data DIN, store the input data DIN for a plurality of clock cycles and output the input data DIN to be delayed data DDO.

The latency FIFO circuit 100 includes a counting circuit 110, a plurality of FIFO buffers 120~122, an input circuit 130 and an output circuit 140.

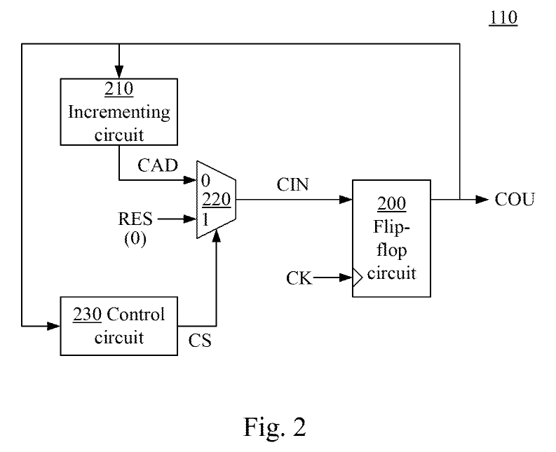

Reference is now made to FIG. 2. FIG. 2 illustrates a block diagram of the counting circuit 110 according to an embodiment of the present invention. The counting circuit 110 in turn generates a counting value COU corresponding to one of a plurality of reference values in a circular manner. In the present embodiment, the counting circuit 110 includes a flip-flop circuit 200, an incrementing circuit 210, a counting multiplexer 220 and a control circuit 230.

The flip-flop circuit 200 receives a counting input value CIN corresponding to a clock signal CK and outputs the counting input value CIN to be the counting value COU. The incrementing circuit 210 receives and increments the counting value COU according to a constant, which is such as but not limited to 1, to generate an incremented counting value CAD.

The counting multiplexer 220 receives the incremented counting value CAD and a reset value RES. In an embodiment, the reset value RES is 0.

The control circuit 230 receives the counting value COU and generates a control signal CS accordingly to the counting multiplexer 220. In an embodiment, the control signal CS is at a first state when the counting value COU equals to a threshold value such that the counting multiplexer 220 selects the reset value RES to be outputted as the counting input value CIN. The control signal CS is at a second state when the counting value COU does not equal to the threshold value such that the counting multiplexer 220 selects the incremented counting value CAD to be outputted as the counting input value CIN. In an embodiment, the first state is a high state and the second state is a low state. However, the present invention is not limited thereto.

The threshold value described above determines the maximum value that the counting circuit 110 counts. In the present embodiment, the condition that the number of the reference values is 3 is used as an example to delay the data for 3 clock cycles. As a result, the threshold value is set to be 2. Under such a condition, the reference values are 0, 1 and 2. More specifically, if the counting value COU is 0 in an initial state, the counting circuit 110 in turn generates the counting value COU of 0, 1 and 2, each being one of the reference values. When the counting value COU reaches 2, the counting circuit 110 resets the counting value COU to be 0 to perform the counting of the next cycle. The operation described above is performed repeatedly. In another embodiment, the number of the reference values can be larger than or smaller than 3.

Each of the FIFO buffers 120~122 corresponds to a corresponding one of the reference values and has one of stored data SA0~SA2. In the present embodiment, the FIFO buffers 120~122 in turn correspond to the reference values of 0, 1 and 2 and respectively have the stored data SA0, SA1 and SA2.

The input circuit 130 receives the input data DIN and write the input data DIN to one of the FIFO buffers 120~122 according to the counting value COU.

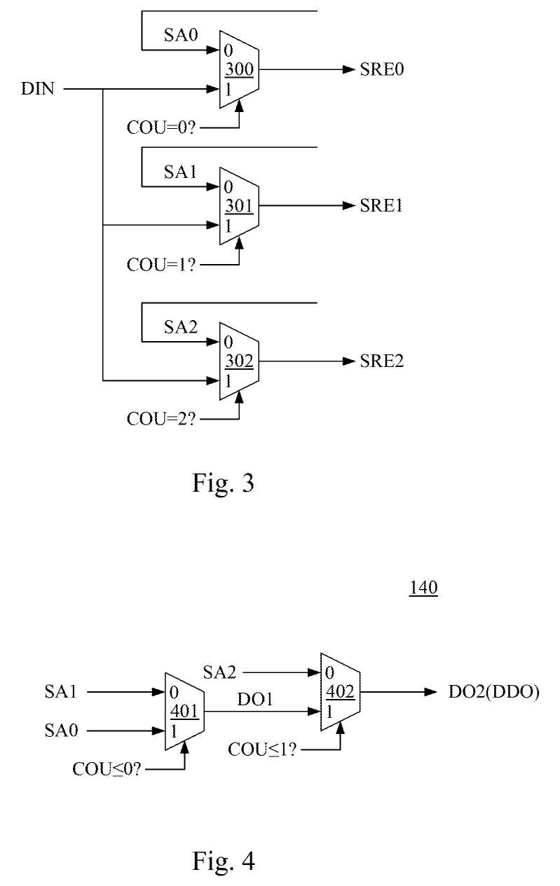

Reference is now made to FIG. 3. FIG. 3 illustrates block diagram of the input circuit 130 according to an embodiment of the present invention. The input circuit 130 includes a plurality of input multiplexers 300, 301 and 302 corresponding to the FIFO buffers 120~122. Each of the input multiplexers includes a first input terminal, a second input terminal, an output terminal and a control terminal.

Take the input multiplexer 300 as an example, the first input terminal thereof receives the input data DIN. The second input terminal of the input multiplexer 300 receives the stored data SA0 of the corresponding FIFO buffer 120. The output terminal of the input multiplexer 300 transmits a selection result SRE0 to the corresponding FIFO buffer 120 to be stored as the stored data SA0.

The control terminal receives the counting value COU so as to select the input data DIN of the first input terminal to be outputted to the output terminal as the selection result SRE0 when the counting value COU matches the corresponding one of the reference values, and select the stored data SA0 of the second input terminal to be outputted to the output terminal as the selection result SRE0 when the counting value COU does not match the corresponding one of the reference values. More specifically, under the condition that the input multiplexer 300 corresponds to the FIFO buffer 120 and the FIFO buffer 120 corresponds to the reference value that is 0, the input multiplexer 300 outputs the input data DIN to be the selection result SRE0 when the counting value COU is 0 and outputs the stored data SA0 to be the selection result SRE0 when the counting value COU is not 0. The FIFO buffer 120 further stores the selection result SRE0 to be the stored data SA0.

Each of the input multiplexers 301 and 302 has a configuration and an operation identical to those of the input multiplexer 300 to receive the stored data SA1 and SA2 from the corresponding FIFO buffers 121 and 122 and determine whether the counting value COU matches the corresponding one of the reference values of 1 and 2. The selections between the input data DIN and the stored data SA1, as well as between the input data DIN and the stored data SA2, are performed accordingly to output the selection results SRE1 and SRE2 to be stored by the corresponding FIFO buffers 121 and 122. The detail is not described herein.

The output circuit 140 selects one of the stored data SA0~SA2 from the FIFO buffers 120~122 based on the counting value COU, and outputs the selected data as delayed data DDO.

Reference is now made to FIG. 4. FIG. 4 illustrates a block diagram of the output circuit 140 according to an embodiment of the present invention. The output circuit 140 includes a plurality of output multiplexers 401~402 coupled in series.

The N-th output multiplexers of all the output multiplexers has a first input terminal, a second input terminal, an output terminal and a control terminal, where N is a positive integer.

The first input terminal receives the stored data of the N+1-th FIFO buffer of the FIFO buffers that corresponds to the N+1-th reference value in the predetermined order, wherein the first input terminal of the last output multiplexer receives the stored data of the last FIFO buffer of the FIFO buffers corresponding to the last reference value in the predetermined order.

The second input terminal receives output data generated by the N-1-th output multiplexer. However, the second input terminal of the first output multiplexer receives the stored data of the first FIFO buffer corresponding to the first reference value in the predetermined order.

The control terminal receives the counting value COU so as to select the stored data of the first input terminal to be outputted to the output terminal when the counting value is larger than the N-th reference value in the predetermined order and select the output data of the second input terminal to be outputted to the output terminal when the counting value is not larger than the N-th reference value. The output terminal of the last output multiplexer outputs the delayed data DDO.

In an embodiment, the reference values are arranged in such as but not limited to an order from the smallest value to the largest value. Take the reference values including 0, 1 and 2 as an example, the first to the third reference values are in the order from the smallest value to the largest value, which are 0, 1 and 2.

For the embodiment in FIG. 4, the first input terminal of the first (N=1) output multiplexer 401 receives the stored data SA1 in the FIFO buffer 121 corresponding to the second reference values (which is 1). The second input terminal of the first output multiplexer 401 receives the stored data SA0 in the FIFO buffer 120 corresponding to the first reference value (which is 0). The first output multiplexer 401 selects the stored data SA1 to be outputted when the counting value COU is larger than the reference value that is 0 and selects the stored data SA0 to be outputted when the counting value COU is not larger than the reference value that is 0.

The first input terminal of the second (N=2) output multiplexer 402 receives the stored data SA2 in the FIFO buffer 122 corresponding to the third reference values (which is 2). The second input terminal of the second output multiplexer 402 receives the output data DO1 generated by the first output multiplexer 401. The second output multiplexer 402 selects the stored data SA2 to be outputted when the counting value COU is larger than the reference value that is 1 and selects the output data DO1 to be outputted when the counting value COU is not larger than the reference value that is 1.

Since the third reference value is the last reference value, the second output multiplexer 402 is the last output multiplexer. The output data DO2 generated therefrom is the delayed data DDO.

It is appreciated that the number of the input multiplexers included by the input circuit 130 and the number of the output multiplexers included by the output circuit 140 are different when the number of the FIFO buffers that corresponds to the number of the reference values is different. Further, in different embodiments, the input circuit 130 and the output circuit 140 may be implemented by circuits with other configurations. The present invention is not limited thereto.

As a result, the configuration of the latency FIFO circuit 100 described above is similar to a ring buffer circuit. However, the ring buffer circuit has a read pointer and a write pointer that are controlled independently. The latency FIFO circuit 100 of the present invention uses a single signal to indicate the read operation and the write operation, which is implemented by the counting value COU generated by the counting circuit 110. The data input rate and the data output rate of the latency FIFO circuit 100 are the same such that the conditions of overflow and underflow do not occur. Moreover, the data inputted to the latency FIFO circuit 100 is outputted after a fixed delay time to accomplish the delay mechanism.

In some approaches, the design of the latency FIFO circuit is to couple the FIFO buffers in series to shift the data therebetween. However, if the required delay amount is higher, a large number of FIFO buffers are required. The large amount of data transfer among the FIFO buffers coupled in series in each clock cycle results in a large power dissipation.

The latency FIFO circuit of the present invention uses the timing counting of the counting circuit to perform a read operation and a write operation on the FIFO buffers in a circular manner such that the input data is outputted in a fixed delay time to avoid the power dissipation generated due to the data transfer in different FIFO buffers.

In other embodiments, the latency FIFO circuit 120 in FIG. 1 may use different counting circuit designs to further lower the power dissipation by using different timing counting methods.

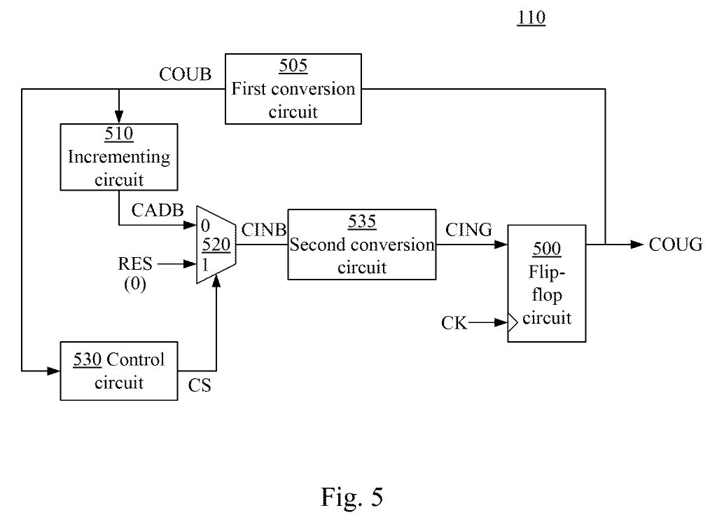

Reference is now made to FIG. 5. FIG. 5 illustrates a block diagram of the counting circuit 110 according to another embodiment of the present invention. In the present embodiment, the counting circuit 110 includes a flip-flop circuit 500, a first conversion circuit 505, an incrementing circuit 510, a counting multiplexer 520, a control circuit 530 and a second conversion circuit 535.

The flip-flop circuit 500, corresponding to the clock signal CK, receives a counting input value CING in a Gray code form and outputs a counting value COUG in the Gray code form.

The first conversion circuit 505 converts the counting value COUG in the Gray code form to the counting value COUB in the binary form.

The incrementing circuit 510 receives and increments the counting value COUB in the binary form according to a constant to generate an incremented counting value CADB in the binary form. In an embodiment, the constant is 1. As a result, the counting value COUB increments the counting value COUB by 1 to generate the incremented counting value CADB.

The control circuit 530 receives the counting value COUB in the binary form to generate the control signal CS to the counting multiplexer 520 accordingly. In an embodiment, the control signal CS is at a first state when the counting value COUB equals to a threshold value such that the counting multiplexer 520 selects the reset value RES to be outputted as the counting input value CINB in the binary form. The control signal CS is at a second state when the counting value COUB does not equal to the threshold value such that the counting multiplexer 520 selects the incremented counting value CADB to be outputted as the counting input value CINB in the binary form. In an embodiment, the first state is a high state and the second state is a low state. However, the present invention is not limited thereto.

Similar to the embodiment in FIG. 2, the threshold value determines the maximum value that the counting circuit 110 counts, in which in the example that the number of the reference values is 3, the threshold value is configured to be 2 such that the counting circuit 110 in turn generates the counting value COUB corresponding to one of the reference values that are 0, 1 and 2. When the counting value COUB reaches 2, the counting value COUB is reset to be 0 to begin a new cycle of counting. The detail is not described herein.

The second conversion circuit 535 converts the counting input value CINB in the binary form to be the counting input value CING in the Gray code form.

In such an example, the counting value COUB in the binary form still increments in the order of 0, 1 and 2, in which these values are represented to be 00, 01, 10 in the binary form. When the values in the binary form are incremented from 01 to 10, the flip-flop circuit 500 needs to modify the states of two bits and consume a larger power. As a result, by using the first conversion circuit 505 and the second conversion circuit 535, the flip-flop circuit 500 actually stores and outputs the counting value COUG in the Gray code form to perform counting in the order of 00, 01 and 11 such that the state of only one bit is required to be modified when the values are incremented from 01 to 11.

It is appreciated that in such an example, when counting values return to 00 from 11, the states of two bits are still required to be modified. However, when the range of the counting numbers is larger, e.g., the reference values include 0~69, most of the increments of the values in the Gray code form performed by the flip-flop circuit 500 only need to modify one bit such that a larger degree of power-saving can be accomplished.

Under the condition that a number of the reference values is close to and not larger than a number 2^{M} that is a power of 2, when the number of the reference values does not equal to such a number (i.e., 2^{M}), the range of the counting value COUB in the binary form does not cover all the values that are not larger than 2^{M}.

Take the embodiment that the number of the reference values is 3 (in which the reference values include 0~2) as an example, the counting value does not reach 3. As a result, when the counting circuit 110 in FIG. 5 is used, the control terminals of the input multiplexers 300~302 of the input circuit 130 in FIG. 3 and the control terminals of the output multiplexers 401~402 of the output circuit 140 in FIG. 4 still need to receive the counting value COUB in the binary form converted by the first conversion circuit 505 when the number of the reference values is not the power of 2. The input multiplexers 300~302 and the output multiplexers 401~402 cannot operate directly according to the counting value COUG in the Gray code form since the values 11 in the Gray code form (corresponding to the value 10 in the binary form) cannot be recognized by these multiplexers.

However, when the number of the reference values is the power of 2, all the values that are not larger than such a number can be covered. The control terminals of the input multiplexers 300~302 and the output multiplexers 401~402 may receive either the counting value COUB in the binary form or the counting value COUG in the Gray code form.

Under such a condition, the counting value COUG in the Gray code form is not required to be processed by the first conversion circuit 505 such that a smaller delay is obtained comparing to the method that uses the counting value COUB in the binary form that is generated by the first conversion circuit 505. The input multiplexers 300~302 and the output multiplexers 401~402 can operate in a shorter timing cycle.

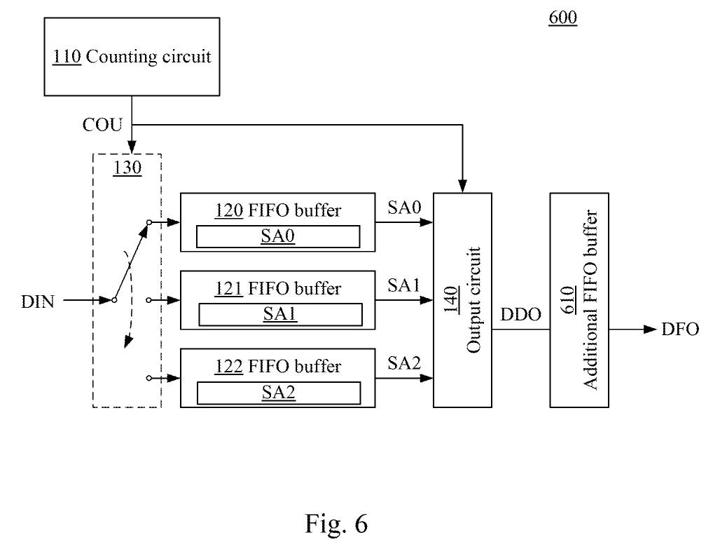

Reference is now made to FIG. 6. FIG. 6 illustrates a block diagram of a latency FIFO circuit 600 having a low power dissipation mechanism according to an embodiment of the present invention. Similar to the latency FIFO circuit 100 in FIG. 1, the latency FIFO circuit 600 includes the counting circuit 110, the FIFO buffers 120~122, the input circuit 130 and the output circuit 140. The identical configuration and operation of the components are not described herein.

Different from the latency FIFO circuit 100 in FIG. 1, the latency FIFO circuit 600 further includes an additional FIFO buffer 610 to receive the delayed data DDO and generate further delayed data DFO. Under such a condition, the latency FIFO circuit 600 may accomplish the last delay cycle of the stored input data DIN by using the additional FIFO buffer 610 such that the timing violation does not occur due to the existence of the output circuit 140.

It is assumed that, in conventional method, the dynamic power consumed by the sequential data transfer among the P FIFO buffers coupled in series is 1 unit, the latency FIFO circuit in FIG. 1 of the present invention only needs to transfer the data in a single FIFO buffer at a time such that only 1/P units of power are consumed. For the latency FIFO circuit in FIG. 6 of the present invention, the data in two FIFO buffers are transferred at a time such that only 2/P units of power are consumed. When P is larger, the latency FIFO circuit of the present invention can reduce the dynamic power dissipation in a greater deal.

The latency FIFO circuit of the present invention reads and writes FIFO buffers in turn in a circular manner according to a time counting of a counting circuit such that input data is outputted after a fixed delay time to avoid the extra power dissipation of data transfer among different FIFO buffers.

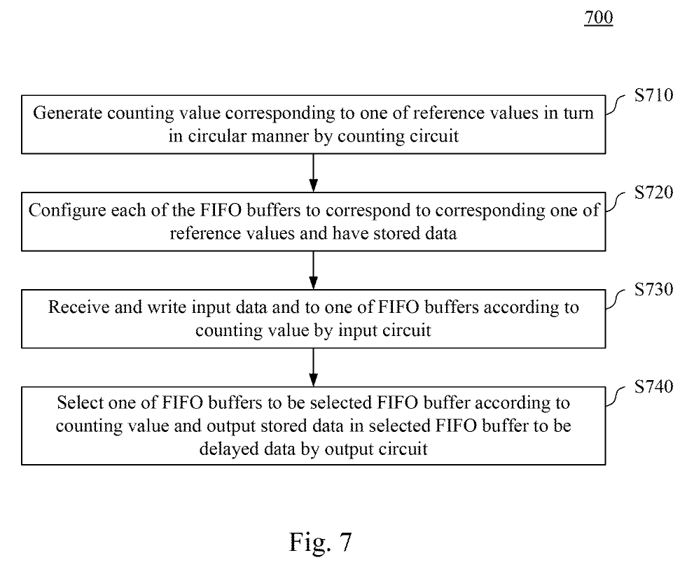

Reference is now made to FIG. 7. FIG. 7 illustrates a flow chart of a latency FIFO circuit operation method 700 having a low power dissipation mechanism according to an embodiment of the present invention.

In addition to the apparatus described above, the present disclosure further provides the latency FIFO circuit operation method 700 having the low power dissipation mechanism that can be used in such as, but not limited to, the latency FIFO circuit 100 in FIG. 1. As illustrated in FIG. 7, an embodiment of the latency FIFO circuit operation method 700 includes the following steps.

In step S710, the counting value COU corresponding to one of the reference values is generated in turn in the circular manner by the counting circuit 110.

In step S720, Each of the FIFO buffers 120~122 is configured to correspond to the corresponding one of the reference values and have the stored data SA0~SA2.

In step S730, the input data DIN is received and written to one of the FIFO buffers 120~122 according to the counting value COU by the input circuit 130.

In step S740, one of the FIFO buffers 120~122 is selected to be the selected FIFO buffer according to the counting value COU and the stored data (one of the stored data SA0~SA2) in the selected FIFO buffer is outputted to be the delayed data DDO by the output circuit 140.

It is appreciated that the embodiments described above are merely an example. In other embodiments, it should be appreciated that many modifications and changes may be made by those of ordinary skill in the art without departing, from the spirit of the disclosure.

For example, a valid bit can be added to the input data to be stored in the latency FIFO circuit to verify the validity of the data and is removed when the data is outputted from the latency FIFO circuit. The present invention is not limited thereto.

Further, in the embodiment described above, each of the FIFO buffers of the latency FIFO circuit are described in the form of a first-in-first-out (FIFO) circuit. However, in some embodiments, each of the FIFO buffers can be a memory unit in a memory circuit (not illustrated in the figure). The counting value serves as a write address and a read address to access the memory unit simultaneously. An enabling time period and a disabling time period of each of a write enable signal and a read enable signal of the memory circuit can be configured according to practical requirements to accomplish the circular write and read operations performed on the memory unit.

In summary, the present invention discloses the latency FIFO circuit and operation method thereof having a low power dissipation mechanism to read and write FIFO buffers in turn in a circular manner according to a time counting of a counting circuit such that input data is outputted after a fixed delay time to avoid the power dissipation of data transfer among different FIFO buffers.

The aforementioned descriptions represent merely the preferred embodiments of the present invention, without any intention to limit the scope of the present invention thereto. Various equivalent changes, alterations, or modifications based on the claims of present invention are all consequently viewed as being embraced by the scope of the present invention.

What is claimed is:

1. A latency first-in-first-out (FIFO) circuit having a low power dissipation mechanism comprising:
a counting circuit to in turn generate a counting value corresponding to one of a plurality of reference values in a circular manner;
a plurality of FIFO buffers each corresponding to a corresponding one of the plurality of reference values and having stored data;
an input circuit to receive input data and write the input data to one of the plurality of FIFO buffers according to the counting value; and
an output circuit to select one of the plurality of FIFO buffers to be a selected FIFO buffer according to the counting value and output the stored data in the selected FIFO buffer to be delayed data.

2. The latency FIFO circuit of claim 1, wherein the counting circuit comprises:
a flip-flop circuit to receive a counting input value corresponding to a clock signal and output the counting input value to be the counting value;
an incrementing circuit to receive and increment the counting value according to a constant to generate an incremented counting value;
a counting multiplexer; and
a control circuit to receive the counting value and generate a control signal to the counting multiplexer such that the counting multiplexer selects a reset value to be the counting input value when the counting value equals to a threshold value and selects the incremented counting value to be the counting input value when the counting value does not equal to the threshold value.

3. The latency FIFO circuit of claim 2, wherein the input circuit comprises a plurality of input multiplexers each comprising:
a first input terminal to receive the input data;
a second input terminal to receive the stored data of a corresponding FIFO buffer of the plurality of FIFO buffers;
an output terminal to transmit a selection result to the corresponding FIFO buffer to be stored as the stored data; and
a control terminal to receive the counting value so as to select the input data of the first input terminal to be outputted to the output terminal as the selection result when the counting value matches the corresponding one of the reference values, and select the stored data of the second input terminal to the output terminal as the selection result when the counting value does not match the corresponding one of the reference values.

4. The latency FIFO circuit of claim 2, wherein the reference values are arranged in a predetermined order and the output circuit comprises a plurality of output multiplexers coupled in series, an N-th output multiplexer of the plurality of output multiplexers comprising:
a first input terminal to receive the stored data of an N+1-th FIFO buffer of the plurality of FIFO buffers that corresponds to an N+1-th reference value in the predetermined order;
a second input terminal to receive output data generated by an N-1-th output multiplexer;
an output terminal; and
a control terminal to receive the counting value so as to select the stored data of the first input terminal to be outputted to the output terminal when the counting value is larger than an N-th reference value in the predetermined order and select the output data of the second input terminal to be outputted to the output terminal when the counting value is not larger than the N-th reference value;
wherein the second input terminal of a first output multiplexer of the plurality of output multiplexers receives the stored data of a first FIFO buffer of the plurality of FIFO buffers corresponding to a first reference value in the predetermined order, the first input terminal of a last output multiplexer of the plurality of output multiplexers receives the stored data of a last FIFO buffer of the plurality of FIFO buffers corresponding to a last reference value in the predetermined order and the output terminal of the last output multiplexer outputs the delayed data.

5. The latency FIFO circuit of claim 1, wherein the counting circuit comprises:
a flip-flop circuit to, corresponding to a clock signal, receive a counting input value in a Gray code form and output the counting value in the Gray code form;
a first conversion circuit to convert the counting value in the Gray code form to the counting value in a binary form;
an incrementing circuit to receive and increment the counting value in the binary form according to a constant to generate an incremented counting value in the binary form;
a counting multiplexer;
a control circuit to receive the counting value in the binary form and generate a control signal to the counting multiplexer accordingly such that the counting multiplexer selects a reset value to be outputted as the counting input value in the binary form when the counting value equals to a threshold value and selects the incremented counting value in the binary form to be outputted as the counting input value in the binary form when the counting value does not equal to the threshold value; and
a second conversion circuit to convert the counting input value in the binary form to be the counting input value in the Gray code form.

6. The latency FIFO circuit of claim 5, wherein the input circuit comprises a plurality of input multiplexers each comprising:
a first input terminal to receive the input data;
a second input terminal to receive the stored data of a corresponding FIFO buffer of the plurality of FIFO buffers;
an output terminal to transmit a selection result to the corresponding FIFO buffer to be stored as the stored data; and
a control terminal to receive the counting value so as to select the input data of the first input terminal to be outputted to the output terminal as the selection result when the counting value matches the corresponding one of the reference values and select the stored data of the second input terminal to be outputted to the output terminal as the selection result when the counting value does not match the corresponding one of the reference values;
wherein when a number of the reference values is not a power of 2, the control terminal receives the counting value in the binary form; and
when the number of the reference values is the power of 2, the control terminal receives the counting value in either the binary form or the Gray code form.

7. The latency FIFO circuit of claim 5, wherein the reference values are arranged in a predetermined order and the output circuit comprises a plurality of output multiplexers coupled in series, an N-th output multiplexer of the plurality of output multiplexers comprising:
a first input terminal to receive the stored data of an N+1-th FIFO buffer of the plurality of FIFO buffers that corresponds to an N+1-th reference value in the predetermined order;
a second input terminal to receive output data generated by an N-1-th output multiplexer;
an output terminal; and
a control terminal to receive the counting value so as to select the stored data of the first input terminal to be outputted to the output terminal when the counting value is larger than an N-th reference value in the predetermined order and select the output data of the second input terminal to be outputted to the output terminal when the counting value is not larger than the N-th reference value;
wherein the second input terminal of a first output multiplexer of the plurality of output multiplexers receives the stored data of a first FIFO buffer of the plurality of FIFO buffers corresponding to a first reference value in the predetermined order, the first input terminal of a last output multiplexer of the plurality of output multiplexers receives the stored data of a last FIFO buffer of the plurality of FIFO buffers corresponding to a last reference value in the predetermined order and the output terminal of the last output multiplexer outputs the delayed data;
wherein when a number of the reference values is not a power of 2, the control terminal receives the counting value in the binary form; and
when the number of the reference values is the power of 2, the control terminal receives the counting value in either the binary form or the Gray code form.

8. The latency FIFO circuit of claim 1, further comprising an additional FIFO buffer to receive the delayed data and generate further delayed data.

9. The latency FIFO circuit of claim 1, wherein each of the plurality of FIFO buffers is a memory unit of a memory circuit, and the counting value is a write address and a read address to access the memory unit.

10. A latency FIFO circuit operation method having a low power dissipation mechanism comprising:
in turn generating a counting value corresponding to one of a plurality of reference values in a circular manner by a counting circuit;
configuring each a plurality of FIFO buffers to correspond to a corresponding reference value one of the plurality of reference values and have stored data;
receiving input data and writing the input data to one of the plurality of FIFO buffers according to the counting value by an input circuit; and
selecting one of the plurality of FIFO buffers to be a selected FIFO buffer according to the counting value and outputting the stored data in the selected FIFO buffer to be delayed data by an output circuit.

11. The latency FIFO circuit operation method of claim 10, further comprising:
receiving a counting input value corresponding to a clock signal and outputting the counting input value to be the counting value by a flip-flop circuit comprised by the counting circuit;
receiving and incrementing the counting value according to a constant to generate an incremented counting value by an incrementing circuit comprised by the counting circuit; and
receiving the counting value and generating a control signal to a counting multiplexer by a control circuit, wherein the counting multiplexer and the control circuit are comprised by the counting circuit, such that the counting multiplexer selects a reset value to be the counting input value when the counting value equals to a threshold value and selects the incremented counting value to be the counting input value when the counting value does not equal to the threshold value .

12. The latency FIFO circuit operation method of claim 11, further comprising:
receiving the input data by a first input terminal of each of a plurality of input multiplexers comprised by the input circuit;
receiving the stored data of a corresponding FIFO buffer of the plurality of FIFO buffers by a second input terminal of each of the plurality of input multiplexers;
transmitting a selection result to the corresponding FIFO buffer to be stored as the stored data by an output terminal of each of the plurality of input multiplexers; and
receiving the counting value by a control terminal of each of the plurality of input multiplexers so as to select the input data of the first input terminal to be outputted to the output terminal as the selection result when the counting value matches the corresponding one of the reference values, and select the stored data of the second input terminal to the output terminal as the selection result when the counting value does not match the corresponding one of the reference values.

13. The latency FIFO circuit operation method of claim 11, wherein the reference values are arranged in a predetermined order and the output circuit comprises a plurality of output multiplexers coupled in series, the latency FIFO circuit operation method further comprising:
receiving the stored data of an N+1-th FIFO buffer of the plurality of FIFO buffers that corresponds to an N+1-th reference value in the predetermined order by a first input terminal comprised by an N-th output multiplexer of a plurality of output multiplexers comprised by the output circuit;
receiving output data generated by an N-1-th output multiplexer by a second input terminal comprised by the N-th output multiplexer; and
receiving the counting value by a control terminal comprised by the N-th output multiplexer so as to select the stored data of the first input terminal to be outputted to the output terminal when the counting value is larger than an N-th reference value in the predetermined order and select the output data of the second input terminal to be outputted to the output terminal when the counting value is not larger than the N-th reference value;
receiving the stored data of a first FIFO buffer of the plurality of FIFO buffers corresponding to a first reference value in the predetermined order by the second input terminal of a first output multiplexer of the plurality of output multiplexers, receiving the stored data of a last FIFO buffer of the plurality of FIFO buffers corresponding to a last reference value in the predetermined order by the first input terminal of a last output multiplexer of the plurality of output multiplexers and outputting the delayed data by the output terminal of the last output multiplexer.

14. The latency FIFO circuit operation method of claim 10, further comprising:
corresponding to a clock signal, receiving a counting input value in a Gray code form and outputting the counting value in the Gray code form by a flip-flop circuit comprised by the counting circuit;
converting the counting value in the Gray code form to the counting value in a binary form by a first conversion circuit comprised by the counting circuit;
receiving and incrementing the counting value in the binary form according to a constant to generate an incremented counting value in the binary form by an incrementing circuit comprised by the counting circuit;
receiving the counting value in the binary form and generating a control signal to a counting multiplexer comprised by the counting circuit accordingly by a control circuit comprised by the counting circuit such that the counting multiplexer selects a reset value to be outputted as the counting input value in the binary form when the counting value equals to a threshold value and selects the incremented counting value in the binary form to be outputted as the counting input value in the binary form when the counting value does not equal to the threshold value; and
converting the counting input value in the binary form to be the counting input value in the Gray code form by a second conversion circuit comprised by the counting circuit.

15. The latency FIFO circuit operation method of claim 14, wherein the input circuit comprises a plurality of input multiplexers, the latency FIFO circuit operation method further comprising:
receiving the input data by a first input terminal of each of a plurality of input multiplexers comprised by the input circuit;
receiving the stored data of a corresponding FIFO buffer of the plurality of FIFO buffers by a second input terminal of each of the plurality of input multiplexers;
transmitting a selection result to the corresponding FIFO buffer to be stored as the stored data by an output terminal of each of the plurality of input multiplexers; and
receiving the counting value by a control terminal of each of the plurality of input multiplexers so as to select the input data of the first input terminal to be outputted to the output terminal as the selection result when the counting value matches the corresponding one of the reference values and select the stored data of the second input terminal to be outputted to the output terminal as the selection result when the counting value does not match the corresponding one of the reference values;
wherein when a number of the reference values is not a power of 2, the control terminal receives the counting value in the binary form; and
when the number of the reference values is the power of 2, the control terminal receives the counting value in either the binary form or the Gray code form.

16. The latency FIFO circuit operation method of claim 14, wherein the reference values are arranged in a predetermined order and the output circuit comprises a plurality of output multiplexers coupled in series, the latency FIFO circuit operation method further comprising:
receiving the stored data of an N+1-th FIFO buffer of the plurality of FIFO buffers that corresponds to an N+1-th reference value in the predetermined order by a first input terminal of an N-th output multiplexer of a plurality of output multiplexers comprised by the output circuit;
receiving output data generated by an N-1-th output multiplexer by a second input terminal of the N-th output multiplexer;
receiving the counting value by a control terminal of the N-th output multiplexer so as to select the stored data of the first input terminal to be outputted to an output terminal of the N-th output multiplexer when the counting value is larger than an N-th reference value in the predetermined order and select the output data of the second input terminal to be outputted to the output terminal when the counting value is not larger than the N-th reference value; and
receiving the stored data of a first FIFO buffer of the plurality of FIFO buffers corresponding to a first reference value in the predetermined order by the second input terminal of a first output multiplexer of the plurality of output multiplexers, receiving the stored data of a last FIFO buffer of the plurality of FIFO buffers corresponding to a last reference value in the predetermined order by the first input terminal of a last output multiplexer of the plurality of output multiplexers and outputting the delayed data by the output terminal of the last output multiplexer;
wherein when a number of the reference values is not a power of 2, the control terminal receives the counting value in the binary form; and
when the number of the reference values is the power of 2, the control terminal receives the counting value in either the binary form or the Gray code form.

17. The latency FIFO circuit operation method of claim 10, further comprising:
receiving the delayed data and generating further delayed data by an additional FIFO buffer.

18. The latency FIFO circuit operation method of claim 10, wherein each of the plurality of FIFO buffers is a memory unit of a memory circuit, and the counting value is a write address and a read address to access the memory unit.
